(19) United States
(12) Patent Application Publication
(10) Pub. No.: US 2022/0253037 A1
(43) Pub. Date: Aug. 11, 2022

(54) MONITORING APPARATUS FOR THE IDENTIFICATION OF ANOMALIES AND DEGRADATION PATHS IN A MACHINE TOOL

(71) Applicants: POLITECNICO Dl MILANO, Milano (IT); MACHINING CENTERS MANUFACTURING S.P.A. OPPURE MCM S.P.A., Vigolzone (PC) (IT)

(72) Inventors: Bianca Maria COLOSIMO, Milano (IT); Marco Luigi Giuseppe GRASSO, Milano (IT); Giuseppe FOGLIAZZA, Ponte dell'Olio (PC) (IT)

(73) Assignees: POLITECNICO Dl MILANO, Milano (IT); MACHINING CENTERS MANUFACTURING S.P.A. OPPURE MCM S.P.A., Vigolzone (PC) (IT)

(21) Appl. No.: 17/440,012

(22) PCT Filed: Mar. 23, 2020
(86) PCT No.: PCT/EP2020/057966

§ 371 Date: Sep. 16, 2021

(30) Foreign Application Priority Data
Mar. 27, 2019 (IT) 102019000004617

(51) Int. Cl. G05B 19/4065

(52) U.S. Cl. CPC G05B 19/4065; G05B 2219/34291; G05B 2219/50203

(57) ABSTRACT

A monitoring apparatus for the identification of anomalies and degradation paths in a machine tool is disclosed. The monitoring apparatus includes a control system interfaceable with a machine tool and configured for making the machine tool execute a predetermined cycle of operations; a recording system interfaceable with a plurality of sensors in the machine tool, wherein the recording system is configured for collecting operation data of machine tool during the predetermined cycle of operations; and an analysis system configured for receiving the operation data and for executing a statistical and data mining analysis on the operation data, comparing a pattern of the operation data with a predetermined pattern, for identifying any anomalies and degradation paths.

### TECHNICAL FIELD

The present invention relates to a monitoring apparatus for the identification of anomalies and degradation paths in a machine tool. In particular, the present invention concerns an apparatus which can be associated with a machine tool, for carrying out a monitoring and identification of particular states, anomalies or operation changes. In general, the present invention finds an application in the field of monitoring and control systems of machineries and of the performances thereof, and in the field of production systems.

### PRIOR ART

A machine tool is a complex system, composed of several elements and potentially exposed to anomalies and degradation paths. “Anomaly” means a sudden change of the health status of the machine, whereas “degradation” means a gradual worsening of the health status of the machine. Both significant anomalies and an ongoing degradation can lead to malfunctions of the machine tool, including a machine downtime or a worsening of the production quality.

A machine tool comprises “axes” along which a tool can translate as planned by a Programmable Logic Controller (PLC).

Usually, the health status of the axes is evaluated during machine tool check-up and inspection interventions; these interventions are periodically programmed or executed following failures, repairs or other events. This type of tests does not allow to monitor the health status of the machine tool components in a continuous way, hindering implementation of predictive strategies aimed at improving the management of maintenance operations and at avoiding unnecessary downtimes and damages to the system.

As an industry best practice, there are monitoring instruments that also include, in some cases, among the signals acquired and analysed, signals of axis position, axis speed, torque and current/power absorption. A first limit of these instruments is that they are designed to monitor the “process” rather than to monitor the “health status of the system”, and therefore they do not allow the variability associated with the health status of a single machine component to be isolated from other effects such as tool wear, tool degree of use, machined material, process parameters, etcetera. A second limit of these instruments is that they apply distinct control limitations to each signal, with no actual merging of the information coming from different sensors; this involves a loss of information linked to the correlation between different signals, but also a reduced efficacy in characterizing the operation of the machine tool.

Document US2004039478 (A1) relates to an electronic tester of a “fingerprint” of a machine, wherein a controller controls the movements of at least one component of the machine and a device selects, for the measurement, certain movements of the machine to generate an electronic “fingerprint” that is representative of the tool or process condition.

At present there are no industrial instruments that are able to keep effectively under control in a continuous way the health status of the components of a machine tool, in particular of the automation of the machine, so that malfunctions or failures thereof are noticed only when the degradation state is already at such a level as to produce anomalies that are visible to the operator.

### SUMMARY OF THE INVENTION

Object of the present invention is to overcome prior art drawbacks.

In particular, an object underlying the present invention is to provide a machine tool with new capabilities to monitor and collect/manage data, for improving the production.

A further object of the present invention is to effectively extract the information content from a large amount of data measured by the numerous sensors equipping a machine tool, through a “Big Data” approach.

A further object of the present invention is to exploit the information content derived from the sensors of a machine tool, to keep under control in an automated way the process and the health status of the system.

A further object of the present invention is to provide monitoring of a production system comprising one or more machines tools.

These and other objects are achieved by a monitoring apparatus for the identification of anomalies and degradation paths in a machine tool according to the features of the appended claims, that form an integral part of the present description.

An idea underlying the present invention is to provide a monitoring apparatus for the identification of anomalies and degradation paths, which can be associated with a machine tool.

The monitoring apparatus of the present invention comprises: a control system, interfaceable with at least one machine tool and configured for making the at least one machine tool execute a predetermined cycle of operations; a recording system interfaceable with a plurality of sensors in the at least one machine tool and configured for collecting operation data of the at least one machine tool, during the predetermined cycle of operations; an analysis system configured for receiving the operation data and for executing a statistical and data mining analysis on these operation data, comparing a pattern of operation data with a predetermined pattern, for identifying any anomalies and degradation paths.

The monitoring apparatus is thus able to identify anomalies and degradation paths in the machine tool, executing a periodical monitoring of the health status of the machine tool, through executions of predetermined cycles of operations, also called “Fingerprint Cycles”.

The monitoring apparatus of the present invention is moreover able to characterize an own “signature” of the system and to monitor the time evolution thereof.

The analysis system according to the present invention allows merging of information coming from several sensors in the machine tool, thanks to an approach based on data mining and statistical monitoring of the multi-sensor signal pattern, also called “Profile Monitoring”.

Advantageously, the present invention allows optimization of maintenance strategies of the machine tool, also in a predictive way anticipating any possible anomalies and thus reducing the unnecessary machine downtimes.

Advantageously, the present invention allows characterization of the machine tool in a more detailed and meaningful way, contributing to collecting information that is potentially useful for the design evolution of the machine tool itself.

Advantageously, the present invention contributes to optimizing the production process involving the machine tool.

Preferably, the control system is further configured for making the at least one machine tool execute one or more training cycles, called “training” cycles; the recording system is further configured for collecting the operation data during the training cycles and the analysis system is further configured for executing the statistical and data mining analysis during the training cycles, for establishing the predetermined pattern which the operative patterns must be compared with.

According to un further aspect, the present invention provides a monitoring apparatus wherein the recording system is further configured for collecting second operation data of the at least one machine tool, during a generic operation; the second operation data comprise Input/Output states of one or more PLCs, and the analysis system is further configured for receiving the second operation data and for executing the statistical and data mining analysis on the second operation data, comparing a pattern of the second operation data with a second predetermined pattern, for identifying any anomalies and degradation paths in automation components of the at least one machine tool.

Advantageously, the operation data comprise Input/Output states and they are effectively used as a source of information for the continuous monitoring of the machine tool.

Advantageously, by automatically extracting sequences of binary data corresponding to operations that are repeated by the various subsystems during the whole operation, the present invention allows any possible anomalies and degradation paths of the automation of the machine tool to be identified.

Advantageously, the present invention allows a “signature” of the behaviour of each subsystem to be determined, precisely from the Input/Output pattern of the channels included in the acquired sequence.

Furthermore, the present invention allows the machine tool maintenance strategies to be optimized and the unnecessary machine downtimes to be reduced.

According to a further aspect, the present invention relates to a production system comprising at least one machine tool and at least one monitoring apparatus for the identification of anomalies and degradation paths.

Further features and advantages will be more apparent from the following detailed description, of non-limiting preferred embodiments of the present invention, and from the dependent claims that outline preferred and particularly advantageous embodiments of the invention.

### BRIEF DESCRIPTION OF THE DRAWINGS

The invention is shown with reference to the following figures, given by way of non-limiting examples, in which:

FIG. 1 illustrates a first embodiment of a monitoring apparatus according to the present invention.

FIG. 2 illustrates a second embodiment of a monitoring apparatus according to the present invention.

FIG. 3 illustrates a first aspect of the operation of a monitoring apparatus according to the present invention.

FIG. 4 illustrates diagrams that are representative of the first aspect of the operation of a monitoring apparatus according to the present invention.

FIG. 5 illustrates a first example of diagrams that are representative of the identification of anomalies and degradation paths in a machine tool.

FIG. 6 illustrates a second aspect of the operation of a monitoring apparatus according to the present invention.

FIG. 7 illustrates diagrams that are representative of the second aspect of the operation of a monitoring apparatus according to the present invention.

FIG. 8 illustrates a second example of diagrams that are representative of the identification of anomalies and degradation paths in a machine tool.

In the different figures, similar elements will be identified by similar reference numbers.

### DETAILED DESCRIPTION

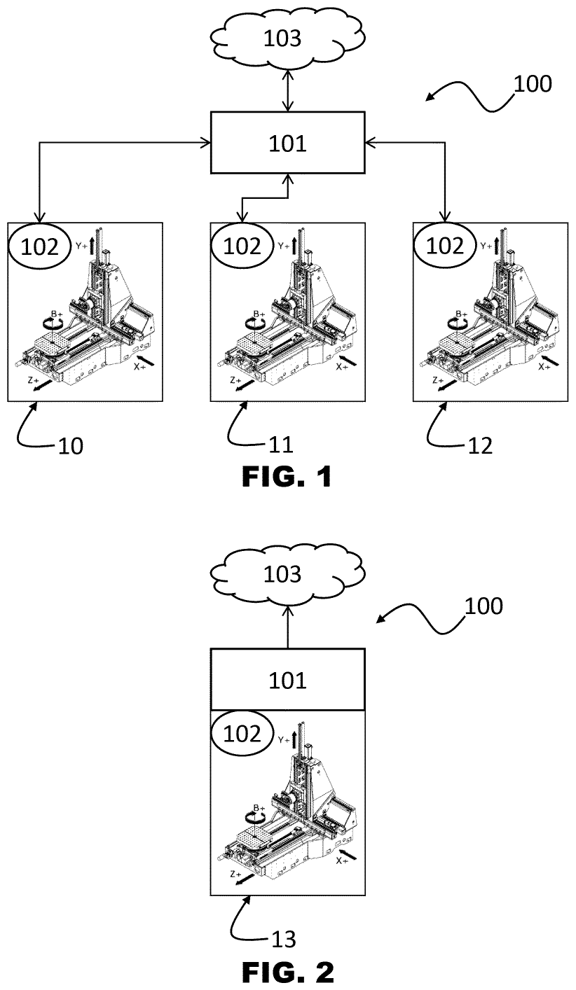

FIG. 1 illustrates a first embodiment of a monitoring apparatus 100 according to the present invention.

The monitoring apparatus 100 is used for monitoring the degradation state and for identifying anomalies in a plurality of machines tools 10, 11 and 12, allowing new predictive maintenance strategies to be implemented.

The term “machine tool” means a machine that is adapted to transform the shape and size of workpieces of any material, by interaction with a tool. Machines tools of the conventional type, such as lathes, cutters, grinders, etcetera are encompassed. Machines tools of the unconventional type, such as laser cutting, waterjet cutting, plasma cutting, etcetera are also encompassed. Machines tools of the innovative type such as systems for “additive manufacturing” etcetera are also encompassed. In general, a machine tool in accordance with the present invention is a system comprising a tool and automation associated with this tool, for modifying properties of a piece being machined; examples of these systems are for example automated welding systems and robotized painting systems.

The production system, in this first embodiment, thus comprises the machines tools 10, 11, 12 and the monitoring apparatus 100, besides known accessory components, anyway encompassed but that are not here described for brevity. The monitoring apparatus 100 comprises a control system 101, interfaceable with the machine tool 10, 11 and 12 and configured for making each of these machines tools 10, 11 and 12 execute a respective predetermined cycle of operations. The control system 101 can be a part of the automation of the production shop floor, for example a system at a centralized level.

The monitoring apparatus 100 then comprises a recording system 102, interfaceable with each machine tool 10, 11 and 12 respectively and in particular interfaceable with a respective plurality of sensors of each machine tool 10, 11 or 12. The recording system 102 is configured for collecting operation data of the at least one machine tool 10, 11 or 12 during the execution of said predetermined cycle of operations. These operation data can comprise: axis position, axis speed, current absorption, power absorption, Input/Output states of a Programmable Logic Controller or PLC, etcetera.

For this purpose, the recording system 102 provides to interface with a plurality of sensors already available in the at least one machine tool 10, 11 or 12. Moreover, the plurality of sensors which the recording system 102 interfaces with can further comprise one or more dedicated sensors, directly installed in association with the monitoring apparatus 100, preferably comprising an accelerometer.

The monitoring apparatus 100 also comprises an analysis system 103, configured for receiving the operation data recorded by the recording system 102 and for executing a statistical and data mining analysis on these operation data.

Preferably, in the monitoring apparatus 100 the statistical and data mining analysis comprises a multivariate principal component analysis on the operation data coming from the plurality of sensors. More preferably, this statistical and data mining analysis also comprises a space-time analysis on the operation data.

In particular, the analysis system 103 is configured for comparing a pattern of the operation data recorded with a predetermined pattern, for identifying any anomalies and degradation paths in each of the machines tools 10, 12 and 12.

The monitoring apparatus 100 thus preferably uses signals already available in the machine tool 10, 11 or 12 (for example, axis positions and speeds, driver current and power absorptions, Input/Output states of the PLC, etcetera) that are acquirable with no need for additional sensors, or dedicated signals, for characterizing the “signature” that is representative of the normal health status of the machine tool and of the most critical components thereof, and for determining deviations from this signature that are indicative of degradation states, incipient failures or out-of-control operating conditions.

The monitoring apparatus 100 provides to refer to a predetermined cycle of operations, the so-called “Fingerprint Cycle”. This predetermined cycle of operations preferably comprises predetermined operations periodically carried out (for example, once a week) by the at least one machine tool 10, 11 or 12, specifically for the identification of the anomalies and of the degradation paths. Preferably, the predetermined operations of the “Fingerprint Cycle” are carried out without working on a workpiece, i.e. loadless.

Whenever the predetermined cycle of operations is executed, multiple signals from sensors embedded in the machine tool 10, 11 or 12 are acquired through an instrument called “Flight Recorder” integrated in the recording system 102 and are sent to the analysis system 103 that preferably comprises a cloud analysis and data storage platform. The cloud-based analysis platform allows one or more production systems to be more effectively monitored, even complex ones, each comprising one or more machine tools.

The analysis system 103 provides to use an algorithm based on statistical analysis and data mining techniques, for analysing the multi-sensor pattern that can be seen as a “signature of the cycle” and comparing it with a pattern observed during a previous training phase, that will be further described.

The algorithm is thus able to determine the present signature of the cycle that is representative of a degraded health status of the machine. The analysis system 103 provides different thresholds to signal a warning, in the presence of degradation states at an early stage, or an alert in case of failures or advanced degradation states.

When applied for example to a lathe, the monitoring apparatus 100 allows, during the whole service life of the machine tool, to keep under control the health status of the axes, and in case of addition of accelerometer sensors, also of the spindle.

FIG. 2 illustrates a second embodiment of a monitoring apparatus 100 according to the present invention.

In this embodiment, the monitoring apparatus 100 comprises a control system 101 and a recording system 102, that are dedicated to the single machine tool 13.

The control system 101 and the recording system 102 can be components spaced apart from each other, or both contained in the machine tool 13.

Moreover, the monitoring apparatus 100 comprises an analysis system 103, similar to what has been described and based on a cloud platform.

The production system, in this second embodiment, thus comprises the machine tool 13 and the monitoring apparatus 100, besides known accessory components, anyway encompassed but that are not here described for brevity.

In an alternative embodiment (not shown), the analysis system 103 could be locally confined in the machine tool 13, or in close proximity to it, without using cloud technologies.

In other words, several implementations at a physical level of the control system 101, of the recording system 102 and of the analysis system 103 are possible.

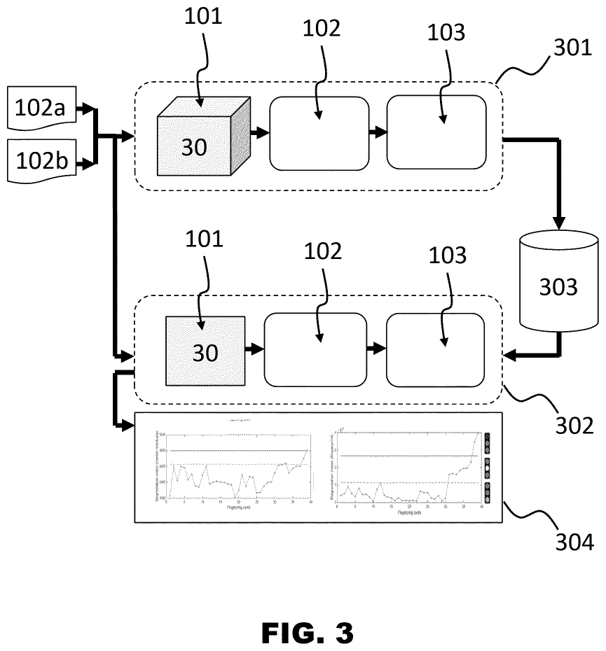

FIG. 3 illustrates a first aspect of the operation of a monitoring apparatus 100 according to the present invention.

As already described, the “Fingerprint Cycle” consists of a series of predetermined operations (advancement along single axes, interpolation of the motion of multiple axes, motion inversions, advancements at different speeds, etcetera) that the control system 101 causes the machine tool to execute, when other machining operations are not provided. The sequences of operations of the predetermined cycle, the duration thereof and the frequency at which it is performed can be customized based on the machine typology and on the specific user requirements.

The monitoring apparatus 100 provides for the execution of two phases, called “training phase” 301 and “monitoring phase” 302 respectively.

During the training phase 301, the “Fingerprint Cycle” 30 is executed a certain number of times, for good operating conditions of the system.

For example, this training phase 301 could be executed after the installation and the inspection of the machine tool, or it could be updated following interventions on the system, refurbishment operations, etcetera.

During the execution of each cycle the signals that represent the analysis input are acquired by the recording system 102. These signals preferably include quantities available from sensors 102a “embedded” in the machine tool, but signals acquired through external sensors 102b can also be added.

The acquired signals are sent on the cloud platform of the analysis system 103 and stored in a database 303. Again on the cloud platform, the data mining algorithm processes the signals and estimates, for each cycle, a performance index whose time trend is representative of the time stability of the intrinsic “signature” in the multi-sensor pattern of the input signals.

Besides the estimation of this index, the analysis system 103 automatically determines a control chart characterized by different thresholds, at least one warning threshold and one alert threshold.

Therefore, the control system 101 is further configured for making the at least one machine tool 10, 11, 12 or 13 execute one or more training cycles 30, and the recording system 102 is further configured for collecting the operation data during the training cycles 30.

The analysis system 103 is further configured for executing the statistical and data mining analysis of the operation data during the training cycles 30, for establishing the predetermined pattern.

The analysis system 103 is further configured for storing in the database 303 historical series of the operation data.

Once the training phase 301 is finished, the already-described monitoring phase 302 can automatically start. The monitoring phase 302 spans over the whole operating period of the machine tool, up to the execution of a new training phase 301.

During the monitoring phase 302, a “Fingerprint Cycle” 30 is periodically executed, the signals are acquired by the recording system 102 and thus sent to the analysis system 103 on the cloud.

The data-mining algorithm of the analysis system 103 estimates the performance index for this new “Fingerprint Cycle” 30; based on how the calculated index sets with respect to the thresholds previously estimated in the training phase 301, a warning or an alert can be signalled.

The control chart, with the time trend of the performance index, is updated at each new execution of the predetermined cycle 30, allowing the evolution of the health status of the system to be graphically observed on the interface 304.

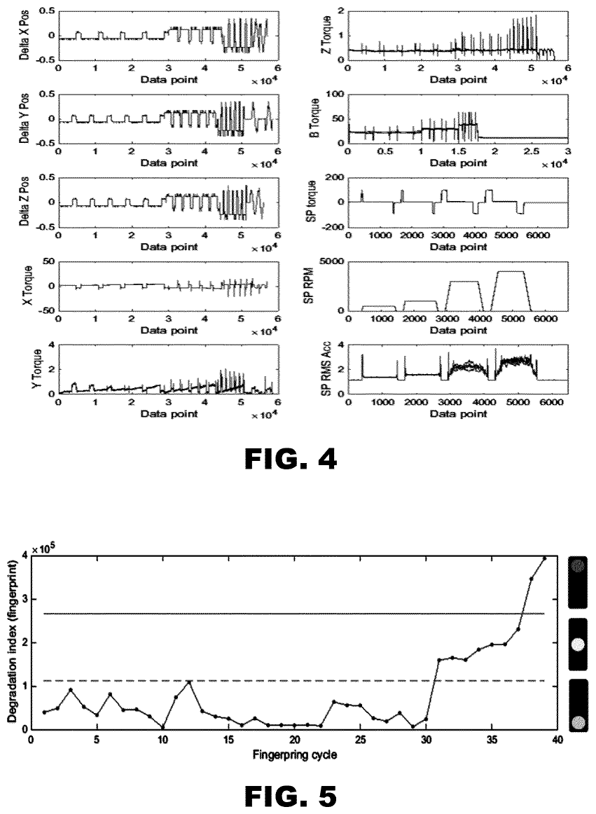

FIG. 4 illustrates diagrams that are representative of a first aspect of the operation of a monitoring apparatus 100 according to the present invention.

The values measured by the plurality of sensors from the recording system 102, for a respective plurality of physical quantities are here represented.

FIG. 5 illustrates a first example of diagrams that are representative of the identification of anomalies and degradation paths in a machine tool.

In general, the analysis system 103 is further configured for calculating a degradation index associated with the pattern of the operation data, and preferably for providing through the interface 304 a warning indication and/or an alert indication upon exceeding a predetermined threshold. In fact, the interface 304 of the analysis system 103 is configured for graphically representing a time evolution of the degradation index.

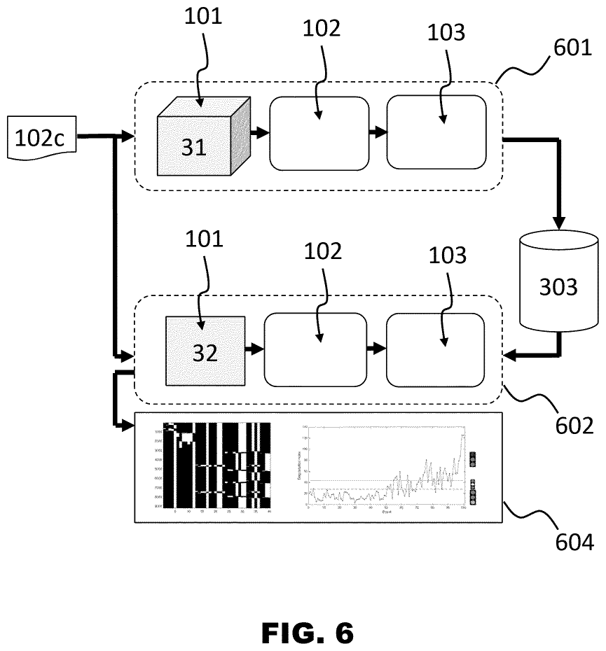

FIG. 6 illustrates a second aspect of the operation of the monitoring apparatus 100 according to the present invention.

According to an embodiment, the monitoring apparatus 100 also allows anomalies and degradation paths of the automation components (for example, pallet exchanger, tool attachment/release pliers, ports, etcetera) of the machine tool to be identified.

This identification mode is complementary and additional to the above-described first identification mode, and it allows the health status of the machine tool to be kept under control even without having to periodically execute predetermined cycles of operations or “Fingerprint Cycles”, since the same monitoring apparatus 100 is further able to automatically extract, during the normal operation of the machine tool, sequences of binary data that are representative of Input/Output states of the PLC associated with subsystems of the automation recorded by suitable logic sensors 102c.

Each sequence consists of a certain number of Input/Output channels, whose binary data map can be construed as a “signature” of the health status of that particular subsystem; the multi-channel pattern observed in each sequence is sent to the platform of the analysis system 103, preferably remote on the cloud.

During the normal operation of the machine 602, a statistical analysis and data mining algorithm similar to what has already been described, analyses the pattern of the last observed sequence 32, it compares it with the reference pattern 31 observed during a previous training phase 601, and it determines whether the present signature is representative of a degraded health status.

Similarly to what has been described above, this second instrument too provides for different thresholds for signalling a warning, in the presence of degradation states at an early stage, or an alert in case of failures or advanced degradation states, preferably through a graphical user interface 604.

In general, the recording system 102 is further configured for collecting second operation data of the at least one machine tool during a generic operation 602, wherein the second operation data comprise Input/Output states of one or more PLCs recorded by the system 102c. The analysis system 103 is further configured for receiving the second operation data 32 and for executing the statistical and data mining analysis on the second operation data 32, comparing a pattern of the second operation data 32 with a second predetermined pattern determined as from the data 31 in the training phase 601. In this way, the monitoring apparatus 100 is adapted to identify any anomalies and degradation paths in the automation components of the at least one machine tool.

In particular, the analysis system 103 is further configured for calculating a degradation index associated with the pattern of the second operation data, and for providing a second warning indication and/or a second alert indication upon exceeding a second predetermined threshold, on the user interface 604.

It must be noted that in this case no predetermined cycle is periodically executed, since the recording system 102 is able to automatically extract sequences of binary signals associated with operations that are repeated by the subsystems of the automation of the machine, during the whole service life of the system.

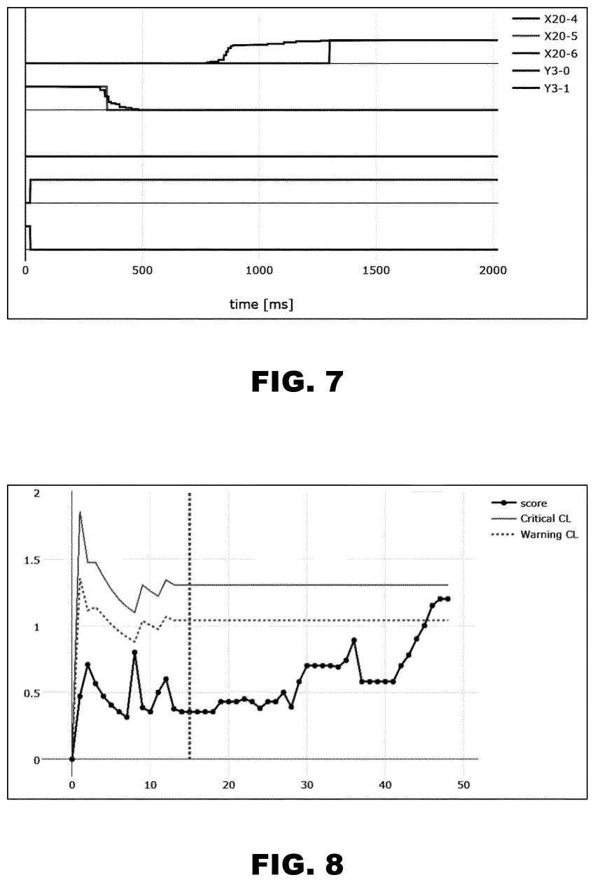

FIG. 7 illustrates diagrams that are representative of a second aspect of the operation of a monitoring apparatus 100 according to the present invention.

These sequences consist in the time evolution of states 0-1 corresponding to the Input/Output states of the PLC acquired at a suitable frequency (for example, 10 ms).

Each sequence preferably includes multiple channels, since it corresponds to a sequence of operations which involves multiple components of the subsystem.

For each monitored subsystem, repetitions of the same sequence are thus acquired, whose “signature” should maintain steady in time until remaining in good operating conditions. As the degradation state of one or more components of the subsystem increases, the signature that is representative of the sequence should increasingly deviate from the reference signature.

In the example, it is provided to monitor the opening of a tool change port (open, closed, opening phase), the opening of a tool change door.

FIG. 8 illustrates a second example of diagrams that are representative of the identification of anomalies and degradation paths in a machine tool.

Thanks to a graphical interface, the operator has the possibility to display a graphical representation of the binary signals included in each sequence, for comparing the present sequence with the reference one and obtaining information that are useful to estimate the nature of the detected malfunction or degradation state; moreover, the operator has the possibility to display a control chart that shows the time trend of the performance index, for evaluating the evolution of the health status of the monitored components.

### INDUSTRIAL APPLICABILITY

The present invention allows a supervision system capable of optimizing the management of the operations at different hierarchical levels to be integrated in a machine tool, based not only on the state of use of the single machine tool, but also based on the health status of the single components thereof.

The monitoring apparatus for the identification of anomalies and degradation paths in a machine tool according to the present invention, fits into the context of the advanced manufacturing solutions and smart factories, improving the digitalization of the processes and of the systems, the “Big Data” management and the combination/integration of information from multiple sensors, the cloud computing.

The present invention allows the machine tool to be brought to a new and more advanced level of intelligence and autonomy as well, due to the continuous collection of data regarding the operating state and a more effective use of the data already available on board the machine.

The present invention is mainly directed to the end-users of machines tools and production systems, but the advantages and benefits deriving therefrom concern both the end-users and the manufacturers of machines tools, which can monitor the operating state of a whole machinery plant installed, obtaining information that are useful for the development of the systems offered to their customers.

Moreover, the monitoring apparatus according to the present invention can be provided during the manufacture of the machine tool, or provided as a retrofit of existing machining centres, with possible sensor integration, to connect the whole machinery installed.

The monitoring apparatus according to the present invention, in the varied components thereof, allows historical series of performance indicators to be analysed for monitoring the time evolution of the health status of the machine tool and of the components thereof, so as to facilitate decisions on when and how to intervene on the system, to bring it back to the desired conditions, performing in a more effective way a “predictive maintenance”.

Taking into account the description herein presented, the person skilled in the art will be able to conceive further modifications and alternatives, in order to meet contingent and specific requirements.

The embodiments herein described shall therefore be construed as illustrative and non-limiting examples of the invention.

1. A monitoring apparatus for the identification of anomalies and degradation paths in a machine tool, said monitoring apparatus comprising:
a control system interfaceable with a machine tool and configured for making said machine tool execute a predetermined cycle of operations;
a recording system interfaceable with a plurality of sensors in said at least one machine tool, said recording system being configured for collecting operation data of said machine tool during said predetermined cycle of operations; and
an analysis system configured for receiving said operation data and for executing a statistical and data mining analysis on said operation data, comparing a pattern of said operation data with a predetermined pattern for identifying any of said anomalies and said degradation paths.

2. The monitoring apparatus according to claim 1, wherein said predetermined cycle of operations comprises predetermined operations periodically carried out by said machine tool, specifically for the identification of said anomalies and said degradation paths.

3. The monitoring apparatus according to claim 2, wherein said predetermined operations are carried out without working on a workpiece.

4. The monitoring apparatus according to claim 1, wherein said statistical and data mining analysis comprises a multivariate principal component analysis on said operation data coming from said plurality of sensors.

5. The monitoring apparatus according to claim 4, wherein said statistical and data mining analysis further comprises a space-time analysis on said operation data.

6. The monitoring apparatus according to claim 1, wherein said control system is further configured for making said at least one machine tool execute one or more training cycles, and wherein said recording system is further configured for collecting said operation data during said one or more training cycles, and wherein said analysis system is further configured for executing said statistical and data mining analysis of said operation data during said one or more training cycles, for establishing said predetermined pattern.

7. The monitoring apparatus according to claim 1, wherein said recording system is further configured for collecting second operation data of said machine tool during a generic operation of said machine tool, wherein said second operation data comprise Input/Output states of one or more PLCs, wherein said analysis system is further configured for receiving said second operation data and for executing said statistical and data mining analysis on said second operation data, comparing a pattern of said second operation data with a second predetermined pattern for identifying any of said anomalies and said degradation paths in automation components of said at least one machine tool.

8. The monitoring apparatus according to claim 7, wherein said analysis system is further configured for calculating a degradation index associated with said pattern of said second operation data,

9. The monitoring apparatus according to claim 1, wherein said analysis system is further configured for storing historical series of said operation data.

10. The monitoring apparatus according to claim 1, wherein said analysis system is further configured for calculating a degradation index associated with said pattern of said operation data.

11. The monitoring apparatus according to claim 10, wherein said analysis system is further configured for graphically representing a time evolution of said degradation index.

12. The monitoring apparatus according to claim 1, wherein said analysis system comprises a cloud data management.

13. The monitoring apparatus according to claim 1, wherein said plurality of sensors comprises sensors available in said machine tool, said available sensors comprising a sensor among: axis position, axis speed, current absorption, power absorption, and Input/Output states of a PLC.

14. The monitoring apparatus according to claim 13, wherein said plurality of sensors further comprises one or more dedicated sensors installed in association with said monitoring apparatus.

15. A production system comprising a machine tool and a monitoring apparatus for the identification of anomalies and degradation paths according to claim 1.

16. The monitoring apparatus according to claim 8, wherein said analysis system is further configured for providing a second warning indication and/or a second alert indication upon exceeding a second predetermined threshold.

17. The monitoring apparatus according to claim 10, wherein said analysis system is further configured for providing a warning indication and/or an alert indication upon exceeding a predetermined threshold.

18. The monitoring apparatus according to claim 14, wherein one or more dedicated sensors comprise an accelerometer.
